(19) United States
(12) Patent Application Publication
(10) Pub. No.: US 2018/0275616 A1
(43) Pub. Date: Sep. 27, 2018

(54) WATCH

(71) Applicant: CITIZEN WATCH CO., LTD., Tokyo (JP)

(72) Inventors: Shoichiro MORITA, Kawagoe-shi (JP); Takashi HOSAKA, Kashiwa-shi (JP); Kaori IZUMI, Tokyo (JP)

(73) Assignee: CITIZEN WATCH CO., LTD., Tokyo (JP)

(21) Appl. No.: 15/928,236

(22) Filed: Mar. 22, 2018

(30) Foreign Application Priority Data
Mar. 23, 2017 (JP) 2017-057258

(51) Int. Cl. G04G 9/12; G04R 60/10; G04B 19/06

(52) U.S. Cl. CPC G04G 9/124; G04B 19/065; G04R 60/10

(57) ABSTRACT

A watch includes a dial plate, a patch antenna, an upper side display component at a visible side than the dial plate, and a lower side display component at the rear surface side of the dial plate. The watch includes a first component layer on which at least a part of a wheel train mechanism for driving the upper side display component and a motor for driving the wheel train mechanism are disposed, and a second component layer that is positioned between the first component layer and the dial plate, and on which the lower side display component and a driving component of the lower side display component are disposed. The patch antenna is disposed on the second component layer so as to be planarly overlapped with a metal component disposed on the first component layer.

### CROSS-REFERENCE TO RELATED APPLICATION(S)

The present application claims priority to and incorporates by reference the entire contents of Japanese Patent Application No. 2017-057258 filed in Japan on Mar. 23, 2017.

### BACKGROUND OF THE INVENTION

### 1. Field of the Invention

The present invention relates to a watch that includes an antenna for receiving satellite radio waves and that displays information by pointers.

### 2. Description of the Related Art

A conventional technique such as that disclosed in Japanese Patent Application Laid-open No. 2016-161380 (paragraphs 0018 to 0021, FIG. 3) is a technique of arrangement inside a movement of a watch that includes an antenna for receiving satellite radio waves and that displays information by pointers. The watch has multiple hands using small hands, and components such as a wheel train, a step motor, and a rear rotary are disposed such that they do not overlap with a patch antenna, in other words, in parallel.

A number of additional functions such as a liquid crystal display device and a date indicator are demanded in the watch as described above. Multiple hands are also in demand.

In the conventional technique, even when an attempt is made to dispose components relating to the additional functions and components relating to the multiple hands in parallel with the antenna to meet the demand, it has been difficult to secure space for disposing the components, because components such as the wheel train, the step motor, and the rear rotary are already aligned in parallel.

Moreover, even when an attempt is made to dispose the components relating to the additional functions and the components relating to the multiple hands at the antenna pointer side, because the components are often made of metal, the reception sensitivity of the antenna may be deteriorated depending on the positional relation between the antenna and the metal components. Furthermore, when the components relating to the additional functions and the components relating to the multiple hands are disposed such that the components relating to the additional functions and the components relating to the multiple hands do not planarly overlap with the antenna, the size of the watch will be increased.

Even if the watch does not have multiple hands, when the components relating to the additional functions are disposed such that the components relating to the additional functions do not planarly overlap with the antenna, the size of the watch may be increased compared with a desirable size.

### SUMMARY OF THE INVENTION

The present invention has been made in view of the above circumstances, and an object of the present invention is to provide ways for arranging components relating to additional functions such as a liquid crystal display device and a date indicator while preventing the size of a watch from being increased, in the watch that includes an antenna for receiving satellite radio waves and that displays information by pointers, and for improving a degree of freedom in designing the arrangement of the components. Moreover, the present invention is capable of preventing the reception sensitivity of the antenna from deteriorating.

A watch according to one aspect of the present invention includes a dial plate; an antenna that receives a satellite radio wave; an upper side display component fitted to a rotation axis projecting toward a visible side than the dial plate; and a lower side display component that is disposed at a rear surface side of the dial plate in an exterior of the dial plate and that is capable of displaying information different from that of the upper side display component, wherein the watch displays time information by at least one of the upper side display component and the lower side display component, a movement in the watch includes a first component layer on which at least a part of a wheel train mechanism for driving the upper side display component, a motor for driving the wheel train mechanism, and a motor driving circuit for driving the motor are disposed, and a second component layer that is positioned between the first component layer and the dial plate, and on which the lower side display component and at least a part of a driving component for driving the lower side display component are disposed, the antenna is disposed on the second component layer so as to be planarly overlapped with a metal component disposed on the first component layer, and a reception circuit component for receiving a predetermined radio wave by the antenna is disposed on the first component layer, the second component layer, or a layer opposite from the second component layer with the first component layer interposed therebetween.

According to another aspect of the present invention, in the watch, the lower side display component may be a liquid crystal panel or a date indicator for displaying a date.

According to still another aspect of the present invention, in the watch, the upper side display component may include a small hand, and a gear fitted to the rotation axis fixed with the small hand may be the metal component.

According to still another aspect of the present invention, in the watch, an operation mechanism that performs an operation relating to a display operation of the upper side display component or the lower side display component using an external operation member may be disposed on the first component layer, and the operation mechanism may be the metal component.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view of a watch according to a first embodiment of the present invention;

FIG. 2 is a plan view illustrating the watch in FIG. 1 including a part of a movement;

FIG. 3 is a sectional view cut along line A-A in FIG. 2;

FIG. 4 is a plan view of a watch according to a second embodiment of the present invention;

FIG. 5 is a plan view illustrating the watch in FIG. 4 including a part of a movement;

FIG. 6 is a sectional view cut along line B-B in FIG. 5;

FIG. 7 is a plan view of a watch according to a third embodiment of the present invention;

FIG. 8 is a plan view illustrating the watch in FIG. 7 including a part of a movement; and

FIG. 9 is a sectional view cut along line C-C in FIG. 8.

### DETAILED DESCRIPTION OF THE PREFERRED EMBODIMENTS

Hereinafter, embodiments of the present invention will be described in detail with reference to the accompanying drawings. The following embodiments are merely examples of the present invention and are not intended to limit the present invention.

### First Embodiment

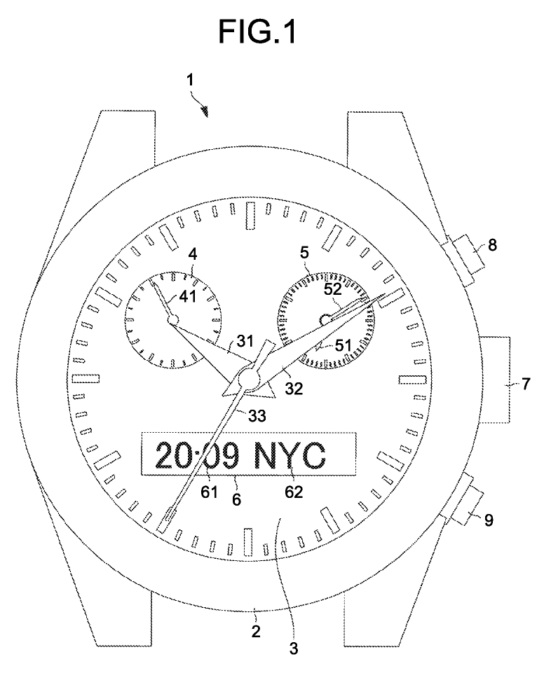

Hereinafter, a first embodiment according to the present invention will be described with reference to the drawings from FIG. 1 to FIG. 3.

FIG. 1 is a plan view of a watch 1 according to the first embodiment of the present invention.

FIG. 1 illustrates a case 2 serving as an exterior of the watch 1, a dial plate 3 provided in the case 2, and an hour hand 31, a minute hand 32, and a second hand 33 for indicating time.

A 24-hour display area 4 is provided in the 10 o'clock direction of the dial plate 3, and the 24-hour display area 4 displays 24 hours by a 24-hour hand 41. A UTC display area 5 is provided in the 2 o'clock direction of the dial plate 3, and the UTC display area 5 displays Coordinated Universal Time by a UTC hour hand 51 and a UTC minute hand 52. A liquid crystal display area 6 is provided in the 6 o'clock direction of the dial plate 3. In FIG. 1, the liquid crystal display area 6 is displaying the time at a predetermined area. The time at the predetermined area is displayed by a liquid crystal time display 61 and a liquid crystal area display 62.

The hour hand 31, the minute hand 32, the second hand. 33, the 24-hour hand 41, the UTC hour hand. 51, and the UTC minute hand 52 are fitted to a rotation axis projecting toward the front side serving as the visible side of the dial plate 3. The hour hand 31, the minute hand 32, the second hand 33, the 24-hour hand 41, the UTC hour hand 51, and the UTC minute hand 52 each correspond to an upper side display component in the present invention. The 24-hour hand 41, the UTC hour hand 51, and the UTC minute hand 52 in the upper side display components except for the hour hand 31, the minute hand 32, and the second hand 33 each correspond to a small hand in the present invention.

A liquid crystal panel 63 including the liquid crystal time display 61 and the liquid crystal area display 62 is provided at the back serving as a rear surface side in the exterior of the dial plate 3. The liquid crystal panel 63 forms the liquid crystal display area 6 through an opening provided in the dial plate 3. The liquid crystal panel 63 corresponds to a lower side display component in the present invention.

Moreover, a stem 7 is provided at a side surface of the case 2 in the 3 o'clock direction side, a first push button 8 is provide on the side surface of the case 2 in the 2 o'clock direction side, and a second push button 9 is provided on the side surface of the case 2 in the 4 o'clock direction side, for a user to perform various operations. The stem 7, the first push button 8, and the second push button 9 each correspond to an external operation member in the present invention.

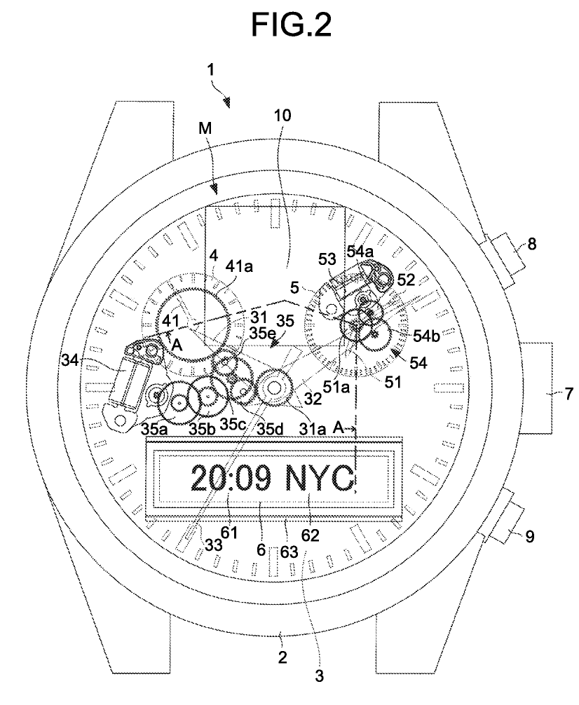

FIG. 2 illustrates a part of a movement M in a state in which the movement M is seen through the dial plate 3 in FIG. 1. In FIG. 2, the dial plate 3 and those disposed at the front side of the dial plate 3 are illustrated with dotted lines, and those disposed at the back of the dial plate 3 are illustrated with solid lines.

An hour motor 34 is disposed at the back of the dial plate 3 in the 9 o'clock direction. The hour motor 34 rotates the hour hand 31 and the 24-hour hand 41 via an hour wheel train 35. The hour wheel train 35 transmits torque to a first hour intermediate wheel 35a, a second hour intermediate wheel 35b, a third hour intermediate wheel 35c, and a fourth hour intermediate wheel 35d this order from the hour motor 34 side, and rotates an hour wheel 31a fitted with the hour hand 31. Moreover, the hour wheel train 35 branches the power of the hour motor 34 by a fifth hour intermediate wheel 35e from the third hour intermediate wheel 35c, and rotates a 24-hour wheel 41a of the 24-hour hand 41.

The hour wheel train. 35 corresponds to a wheel train mechanism for driving the upper side display component, and the hour motor 34 corresponds to a motor for driving the wheel train mechanism in the present invention.

A UTC motor 53 is disposed at the back of the dial plate 3 in the 2 o'clock direction. The UTC motor 53 rotates the UTC hour hand 51 and the UTC minute hand 52 via a UTC wheel train 54. The UTC wheel train 54 transmits torque to a first UTC intermediate wheel 54a from the UTC motor 53 side, and rotates a UTC scoop wheel 51a fitted with the UTC hour hand 51. Moreover, the UTC scoop wheel 51a rotates a second UTC intermediate wheel 54b, and the second UTC intermediate wheel 54b rotates a UTC second wheel, which is not illustrated, of the UTC minute hand 52.

The UTC wheel train 54 corresponds to the wheel train mechanism for driving the upper side display component, and the UTC motor 53 corresponds to the motor for driving the wheel train mechanism in the present invention.

A liquid crystal panel 63 for performing a liquid crystal time display 61 and a liquid crystal area display 62 is disposed at the back of the dial plate 3 in the 6 o'clock direction.

A patch antenna 10 is disposed at the back of the dial plate 3 in the 12 o'clock direction. The patch antenna 10 is for receiving satellite radio waves. For example, the satellite radio waves include time information, and the watch 1 has a function of receiving the satellite radio waves, amending the time, and displaying the time correctly. In the present embodiment, the patch antenna 10 is formed in a rectangular shape. However, the shape of the patch antenna 10 is not limited thereto. An antenna capable of receiving the satellite radio waves such as a ring antenna, a chip antenna, and an inverted-F antenna may also be used instead of the patch antenna 10.

As illustrated in FIG. 2, the patch antenna 10 is disposed such that the patch antenna 10 is overlapped with the front side of a part of the 24-hour wheel 41a, the UTC motor 53, and the UTC scoop wheel 51a.

By disposing the components in this manner, it is possible to dispose the rotation axes of the 24-hour hand 41, the UTC hour hand 51, and the UTC minute hand 52 closer to the patch antenna 10. Consequently, the arrangement of the 24-hour display area 4, the UTC display area 5, and the liquid crystal display area 6 can be designed more freely. Moreover, the 24-hour wheel 41a, the UTC motor 53, and the UTC scoop wheel 51a, which may include metal components, are disposed at a side opposite from the side where the patch antenna 10 receives satellite radio waves. In this manner, because the 24-hour wheel 41a, the UTC motor 53, and the UTC scoop wheel 51a do not block the satellite radio waves received by the patch antenna 10, it is possible to prevent the reception sensitivity from deteriorating.

A motor and a wheel train for rotating the minute hand. 32 and the second hand 33; a substrate; and the like are also disposed in addition to those described above. However, description thereof will be omitted.

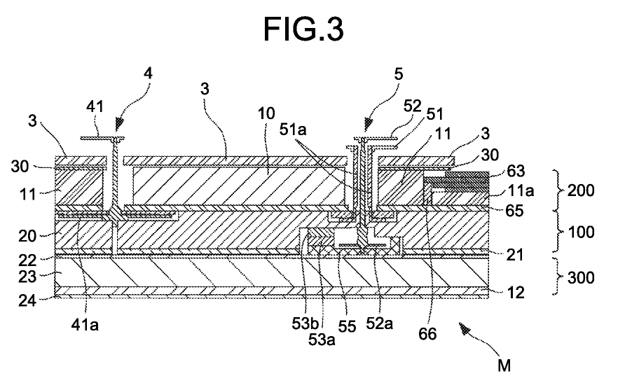

FIG. 3 is a sectional view cut along line A-A in FIG. 2.

The patch antenna 10 is disposed below the dial plate 3 in FIG. 3 on the back of the dial plate 3. Because the patch antenna 10 receives satellite radio waves at the surface of the dial plate 3 side, the patch antenna 10 can properly receive satellite radio waves when the patch antenna 10 is provided at the dial plate 3 side as much as possible as illustrated in FIG. 3.

A solar cell 30 is disposed at the back of the dial plate 3 at a portion where the patch antenna 10 is not disposed. The solar cell 30 is provided for charging a secondary battery, which is not illustrated. Because the solar cell 30 is provided, the dial plate 3 has a structure capable of transmitting or partially transmitting the sunlight.

A support table 11 is provided below the solar cell 30. Like the solar cell 30, a portion of the support table 11 where the patch antenna 10 is to be disposed is opened. Moreover, a liquid crystal panel support unit 11a that is formed in a concave shape and that supports the liquid crystal panel 63 is provided on the support table 11. Furthermore, an opening for passing a liquid crystal substrate connector 66 that electrically connects the liquid crystal panel 63 and a liquid crystal substrate 65 is provided on the support table 11.

The liquid crystal panel 63 is provided on the liquid crystal panel support unit 11a. With such a configuration, the patch antenna 10 and the liquid crystal panel 63 are disposed in parallel.

The liquid crystal substrate 65 is provided below the patch antenna 10 and the support table 11. The liquid crystal substrate 65 is electrically connected to the liquid crystal panel 63 by the liquid crystal substrate connector 66. The liquid crystal substrate 65 drives the liquid crystal panel 63 and corresponds to a driving component for driving the lower side display component in the present invention. Moreover, openings through which the rotation axes of the 24-hour wheel 41a, the UTC scoop wheel 51a, and a UTC second wheel 52a pass are provided on the liquid crystal substrate 65.

The component layer on which the patch antenna 10, the support table 11, the liquid crystal panel 63, the liquid crystal substrate connector 66, the liquid crystal substrate 65, and the like are disposed corresponds to a second component layer 200 in the present invention.

A main plate 20 is disposed below the liquid crystal substrate 65.

A rotation axis of the 24-hour wheel 41a is disposed immediately to the left of the patch antenna 10 in FIG. 3. A gear portion of the 24-hour wheel 41a is disposed below the liquid crystal substrate 65. The right side portion of the 24-hour wheel 41a is disposed below the patch antenna 10, and the left side portion of 24-hour wheel 41a is disposed below the support table 11. The 24-hour wheel 41a is received by the main plate 20.

Rotation axes of the UTC scoop wheel 51a and the UTC second wheel 52a are disposed immediately to the right of the patch antenna 10 in FIG. 3 The gear portions of the UTC scoop wheel 51a and the UTC second wheel 52a are disposed below the liquid crystal substrate 65. The left side portions of the UTC scoop wheel 51a and the UTC second wheel 52a are disposed below the patch antenna 10, and the right side portions of the UTC scoop wheel 51a and the UTC second wheel 52a are disposed below the support table 11.

The UTC scoop wheel 51a is received by the main plate 20. The UTC second wheel 52a is received by a UTC wheel train bridge 55. A coil 53a and a stator 53b of the UTC motor 53 are also disposed below the patch antenna 10, and are received by the UTC wheel train bridge 55. A portion where the UTC wheel train bridge 55 of the main plate 20 is to be disposed is opened.

A watch substrate 21 is disposed below the main plate 20. The watch substrate 21 controls the watch 1, and also includes a motor driving circuit, which is not illustrated, for driving the hour motor 34 and the UTC motor 53.

The component layer on which the main plate 20, the 24-hour wheel 41a, the UTC scoop wheel 51a, the UTC second wheel 52a, the coil 53a and the stator 53b of the UTC motor 53, the UTC wheel train bridge 55, the watch substrate 21, and the like are disposed corresponds to a first component layer 100 in the present invention. A secondary battery, which is not illustrated, for supplying power to the motor driving circuit and the like are also disposed on the first component layer 100.

An anti-magnetic plate 22 is disposed below the main plate 20. The anti-magnetic plate 22 protects the movement, especially the motor, from an external magnetic field.

A circuit support table 23 is disposed below the anti-magnetic plate 22, and a reception substrate 12 is disposed below the circuit support table 23. The reception substrate 12 is electrically connected to the patch antenna 10, and is equipped with various circuits for reception by the patch antenna 10.

The reception substrate 12 corresponds to a reception circuit component in the present invention. The circuit support table 23 and the reception substrate 12 form a reception block 300. In the present embodiment, the reception substrate 12 serving as a reception circuit component for receiving radio waves from a satellite by the patch antenna is disposed on a layer opposite from the second component layer with the first component layer 100 interposed therebetween.

The reception substrate 12 is connected to the watch substrate 21 through a flexible printed circuit (FPC), a coaxial cable, and the like.

A circuit holder 24 for holding the reception substrate 12 is disposed below the reception substrate 12.

As illustrated in FIG. 3, the patch antenna 10 is disposed such that the patch antenna 10 is overlapped with the front side of a part of the 24-hour wheel 41a, the UTC motor 53, and the UTC scoop wheel 51a. Thus, it is possible to bring the 24-hour wheel 41a and the UTC scoop wheel 51a closer to the patch antenna 10, and ease the restrictions on the arrangement of the 24-hour hand 41 and the UTC hour hand 51. Moreover, because the 24-hour wheel 41a and the UTC scoop wheel 51a can be brought closer to the patch antenna 10, it is possible to bring the rotation axes of the 24-hour wheel 41a and the UTC scoop wheel 51a that pass through the second component layer 200 closer to the patch antenna 10 so as not to restrict the space for disposing the liquid crystal panel 63 on the second component layer 200. Thus, it is possible to easily dispose the patch antenna 10 and the liquid crystal panel 63 in parallel.

The components such as the 24-hour wheel 41a, the UTC scoop wheel 51a, the UTC second wheel 52a, the coil 53a and the stator 53b of the UTC motor 53, and the watch substrate 21 are metal components, and these metal components are disposed below the patch antenna. 10. Consequently, these metal components do not block the satellite radio waves received by the patch antenna 10, and it is possible to prevent the reception sensitivity from deteriorating.

If the components disposed on the second component layer 200 are disposed on the first component layer 100, the first component layer 100 spreads in the planar direction, and the exterior of the movement M when the watch 1 is viewed in the plan view will be increased. Thus, the watch 1 will be a wrist watch with a unique exterior larger than a commonly used wrist watch.

Even if the components relating to the liquid crystal panel 63 are disposed on the second component layer 200 because of the structure described above, the exterior of the first component layer 100 is still large, and the second component layer 200 will have an empty space. Thus, it is difficult to sufficiently reduce the exterior of the movement N in the planar direction.

Alternatively, a two-layered structure is formed by overlapping the second component layer 200 on the first component layer 100 including a large number of metal components. The patch antenna 10 is disposed on the second component layer 200, which is less likely to be affected by the metal components on the first component layer 100. Consequently, a degree of freedom in the position of disposing the patch antenna 10 is increased, and it is possible to reduce the area of the first component layer 100 in the planar direction.

Moreover, the patch antenna 10 is disposed on the second component layer 200 where an empty space is created if only a relatively large additional function component such as the liquid crystal panel 63 and the components relating to the additional function component are disposed. Consequently, it is possible to efficiently arrange the components on the second component layer 200, and the components can be dispersed between the first component layer 100 and the second component layer 200 in good balance.

In this manner, it is possible to form the movement M on which the components are more equally arranged in the exterior of the dial plate 3, and implement a wrist watch with a commonly used external size.

### Second Embodiment

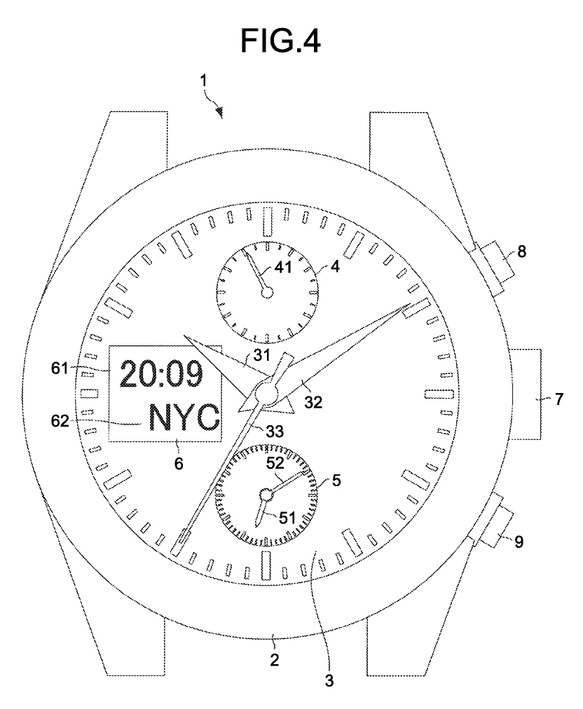

Hereinafter, a second embodiment according to the present invention will be described with reference to the drawings from FIG. 4 to FIG. 6. The descriptions of the same portions as those in the first embodiment are omitted, and portions different from those in the first embodiment will be mainly described.

FIG. 4 is a plan view of the watch 1 according to the second embodiment of the present invention.

In the present embodiment, the 24-hour display area 4 is provided in the 12 o'clock direction of the dial plate 3, and the UTC display area 5 is provided in the 6 o'clock direction. The liquid crystal display area 6 is provided in the 9 o'clock direction of the dial plate 3. In the liquid crystal display area 6, the liquid crystal time display 61 and the liquid crystal area display 62 are displayed in two rows.

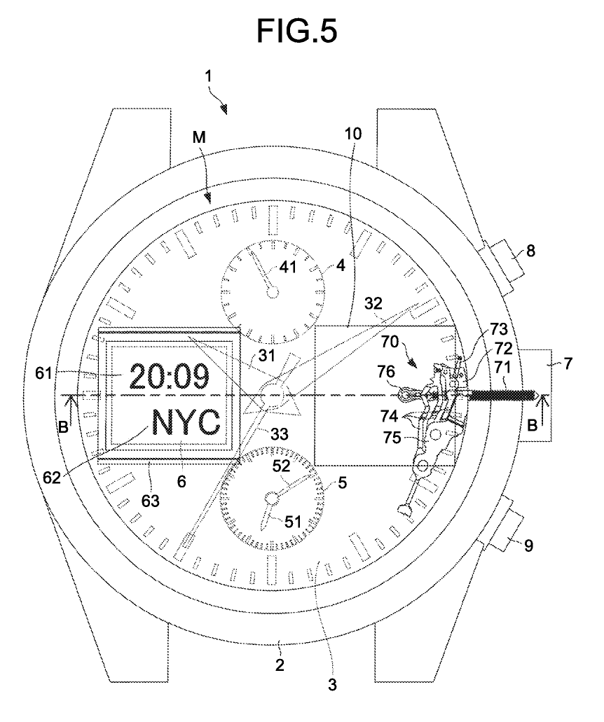

FIG. 5 illustrates a part of the movement M in a state in which the movement M is seen through the dial plate 3 in FIG. 4. In FIG. 5, the dial plate 3 and those disposed at the front side of the dial plate 3 are illustrated with dotted lines, and those disposed at the back of the dial plate 3 are illustrated with solid lines.

The liquid crystal panel 63 for performing the liquid crystal time display 61 and the liquid crystal area display 62 is disposed at the back of the dial plate 3 in the 9 o'clock direction.

A rear rotary 70 is disposed at the back of the dial plate 3 in the 3 o'clock direction. The rear rotary 70 is a mechanism for transmitting an operation of the stem 7 by a user, to change the display modes of the hour hand 31, the minute hand 32, the second hand 33, the 24-hour hand 41, the UTC hour hand 51, the UTC minute hand 52, and the liquid crystal panel 63.

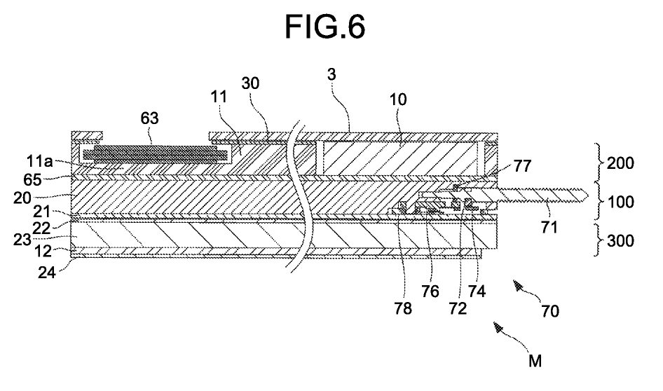

A setting stem 71 is connected to the stem 7 and is fitted in such a way that the setting stem 71 can be rotated, pushed, and pulled. A setting lever 72 is rotated in conjunction with the push and pull operation of the setting stem 71, and rotates a switch spring 73. A setting lever jumper 74 holds the setting stem 71, the setting lever 72, the switch spring 73, and a switch lever 76. The switch lever 76 is operated in conjunction with the rotational movement of the setting stem 71. Reference numeral 75 is a setting wheel plate. Reference numeral 77 is a switch wheel (illustrated in FIG. 6). Reference numeral 78 is a switch lever holder (illustrated in FIG. 6). Most of the components included in the rear rotary 70 are metal components.

The rear rotary 70 corresponds to an operation mechanism in the present invention.

The patch antenna 10 is disposed at the back of the dial plate 3 in the 3 o'clock direction.

As illustrated in FIG. 5, the patch antenna 10 is disposed such that the patch antenna 10 is overlapped with a part of the rear rotary 70 at the dial plate 3 side, in other words, at the front side.

In this manner, the rear rotary 70, which includes metal components, is disposed at the back of the patch antenna 10. Consequently, compared to when the patch antenna 10 and the rear rotary 70 are disposed such that the patch antenna 10 and the rear rotary 70 are shifted from each other, instead of overlapped with each other in the planar view of the watch 1, space for disposing other components will be increased. Thus, the arrangement of the 24-hour display area 4, the UTC display area 5, and the liquid crystal display area 6 can be designed more freely. Moreover, most of the components included in the rear rotary 70 are metal, and are disposed at a side opposite from the side where the patch antenna 10 receives satellite radio waves. In this manner, because the satellite radio waves received by the patch antenna 10 will not be blocked by the rear rotary 70, it is possible to prevent the reception sensitivity from deteriorating.

A motor and a wheel train for rotating the hour hand 31, the minute hand 32, the second hand. 33, the 24-hour hand. 41, the UTC hour hand 51, and the UTC minute hand 52; a substrate; and the like are also disposed in addition to those described above. However, description thereof will be omitted.

FIG. 6 is a sectional view cut along line B-B in FIG. 5.

The component layer on which the patch antenna 10, the support table 11, the liquid crystal panel 63, the liquid crystal substrate 65, and the like are disposed corresponds to the second component layer 200 in the present invention.

A part of the rear rotary 70 is disposed below the patch antenna 10. The rear rotary 70 is continuously provided on the watch substrate 21. A watch microcomputer, which is not illustrated, of the watch substrate 21 is operated when the rear rotary 70 is moved, and changes various display modes.

The component layer on which the main plate 20, the watch substrate 21, the rear rotary 70, and the like are disposed corresponds to the first component layer 100 in the present invention. A battery, which is not illustrated, for supplying power to the wheel train, the motor, and the motor driving circuit, or the like is also disposed on the first component layer 100.

As illustrated in FIG. 6, the patch antenna 10 is disposed such that the patch antenna 10 is overlapped with the rear rotary 70. The other area that is not overlapped with the rear rotary 70 is not occupied by the patch antenna 10, and thus it is possible to secure space for arranging other components.

The rear rotary 70, which includes many metal components, is disposed below the patch antenna 10. In this manner, because the rear rotary 70 does not block the satellite radio waves received by the patch antenna 10, it is possible to prevent the reception sensitivity from deteriorating.

The first push button 8 and the second push button 9 are also movable for changing various display modes. The movable mechanisms of these buttons, such as a switch return spring, which is not illustrated, may also be disposed below the patch antenna 10. In this manner, it is possible to obtain similar effects to those described above. In this case, the movable mechanisms of the first push button 8 and the second push button 9 each correspond to the operation mechanism in the present invention.

### Third Embodiment

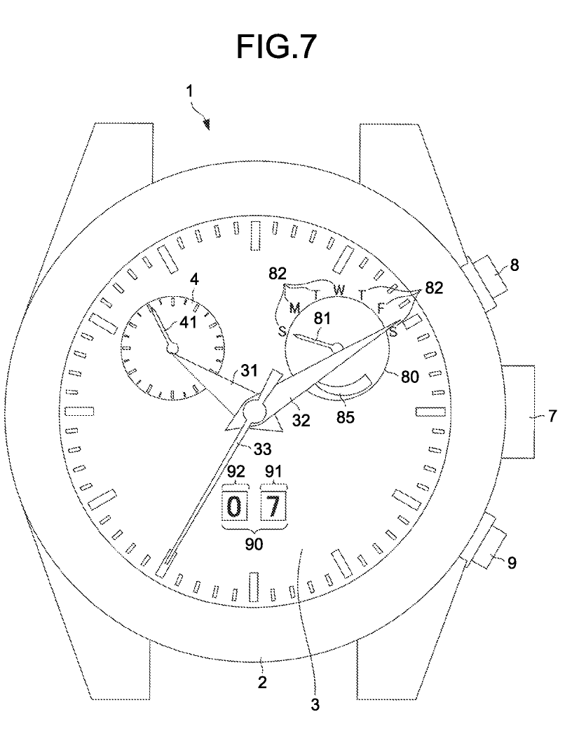

Hereinafter, a third embodiment according to the present invention will be described with reference to the drawings from FIG. 7 to FIG. 9. The descriptions of the same portions as those in the first and the second embodiments are omitted, and portions different from those in the first and the second embodiments will be described.

FIG. 7 is a plan view of the watch 1 according to the third embodiment of the present invention.

The 24-hour display area 4 is provided in the 10 o'clock direction of the dial plate 3. A day display area 80 is provided in the 2 o'clock direction of the dial plate 3, and a day is displayed when a day indicating hand 81 indicates day information 82. Moreover, a charge amount display area 85 for displaying the charge amount of the secondary battery is provided in the day display area 80. The day indicating hand 81 is commonly used for displaying the charge amount of the secondary battery by the charge amount display area 85. In other words, depending on the state of the watch 1, the day indicating hand 81 displays either the day information 82 or the charge amount of the secondary battery. A date display area 90 is provided in the 6 o'clock direction of the dial plate 3. The date display area 90 is formed of a one digit date display area 91 and a tens digit date display area 92.

The hour hand 31, the minute hand 32, the second hand 33, the 24-hour hand 41, and the day indicating hand 81 are fitted to a rotation axis projecting toward the front side serving as the visible side of the dial plate 3. The hour hand 31, the minute hand 32, the second hand 33, the 24-hour hand 41, and the day indicating hand 81 each correspond to the upper side display component in the present invention. The 24-hour hand 41 and the day indicating hand 81 in the upper side display components except for the hour hand 31, the minute hand 32, and the second hand 33 each correspond to a small hand in the present invention.

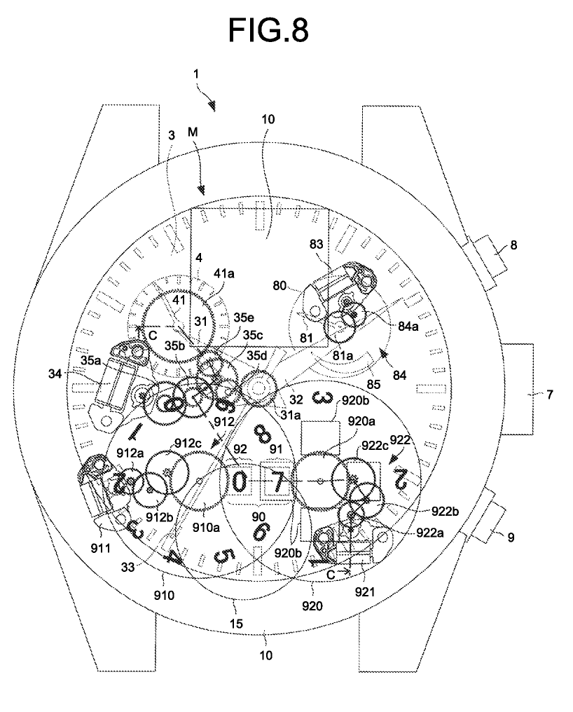

A one digit date indicator 910 and a tens digit date indicator 920 (illustrated in FIG. 8) for displaying a date in the one digit date display area 91 and the tens digit date display area 92 are provided at the back serving as a rear surface side in the exterior of the dial plate 3, and form the date display area 90 through an opening provided on the dial plate 3. The one digit date indicator 910 and the tens digit date indicator 920 each correspond to the lower side display component in the present invention.

FIG. 8 illustrates a part of the movement M in a state in which the movement 4 is seen through the dial plate 3 in FIG. 7. In FIG. 8, the dial plate 3 and those disposed at the front side of the dial plate 3 are illustrated with dotted lines, and those disposed at the back of the dial plate 3 are illustrated with solid lines.

A day motor 83 is disposed at the back of the dial plate 3 in the 2 o'clock direction. The day motor 83 rotates the day indicating hand 81 via a day wheel train 84.

The day wheel train 84 transmits torque to a day intermediate wheel 84a from the day motor 83 side, and rotates a day indicator 81a of the day indicating hand 81.

The day wheel train 81 corresponds to a wheel train mechanism for driving the upper side display component, and the day motor 83 corresponds to the motor for driving the wheel train mechanism in the present invention.

A one digit date indicator 910 is disposed at, the back of the dial plate 3 in the 7 o'clock direction. The numerals from 0 to 9 are assigned to the one digit date indicator 910, and one of the numerals is visible from the opening of the one digit date display area 91 of the dial plate 3.

A one digit date motor 911 is disposed at the back of the dial plate 3 in the 8 o'clock direction. The one digit date motor 911 rotates the one digit date indicator 910 via a one digit date wheel train 912. The one digit date wheel train 912 transmits torque to a first one digit date intermediate wheel 912a, a second one digit date intermediate wheel 912b, and a third one digit date intermediate wheel 912c in this order from the one digit date motor 911 side, and rotates a gear 910a of the one digit date indicator 910.

The tens digit date indicator 920 is disposed at the back of the dial plate 3 in the 5 o'clock direction. The numerals from 0 to 3 are assigned to the tens digit date indicator 920, and one of the numerals is visible from the opening of the tens digit date display area 92 of the dial plate 3. The tens digit date indicator 920 is disposed such that the tens digit date indicator 920 is overlapped with the one digit date indicator 910 at the dial plate 3 side than the one digit date indicator 910. An opening 920b is provided at, a predetermined position of the tens digit date indicator 920 where the numeral assigned to the one digit date indicator 910 is to be overlapped. There are four openings 920b corresponding to the numerals from 0 to 3. The numeral of the one digit date indicator 910 is visible through one of the openings 920b.

A tens digit date motor 921 is disposed at the back of the dial plate 3 in the 5 o'clock direction. The tens digit date motor 921 rotates the tens digit date indicator 920 via a tens digit date wheel train 922. The tens digit date wheel train 922 transmits torque to a first tens digit date intermediate wheel 922a, a second tens digit date intermediate wheel 922b, and a third tens digit date intermediate wheel 922c in this order from the tens digit date motor 921 side, and rotates a gear 920a of the tens digit date indicator 920.

A secondary battery 15 is disposed at the back of the dial plate 3 in the 6 o'clock direction. The secondary battery 15 is also disposed in the rear surface direction than the one digit date indicator 910 and the tens digit date indicator 920.

As illustrated in FIG. 8, the patch antenna 10 is disposed such that the patch antenna 10 is overlapped with the front side of a part of the 24-hour wheel 41a, the day motor 83, and the day indicator 81a of the day indicating hand 81.

By disposing the components in this manner, it is possible to dispose the rotation axes of the 24-hour hand 41 and the day indicating hand 81 closer to the patch antenna 10. Consequently, the arrangement of the 24-hour display area 4, the day display area 80, and the date display area 90 can be designed more freely. Moreover, the 24-hour wheel 41a, the day motor 83, and the day indicator 81a of the day indicating hand 81, which may include metal components, are disposed at a side opposite from the side where the patch antenna 10 receives satellite radio waves. In this manner, because the satellite radio waves received by the patch antenna 10 will not be blocked by these components, it is possible to prevent the reception sensitivity from deteriorating.

A motor and a wheel train for rotating the minute hand 32 and the second hand 33; components relating to the charge amount display area 85; a substrate; and the like are also disposed in addition to those described above. However, description thereof will be omitted.

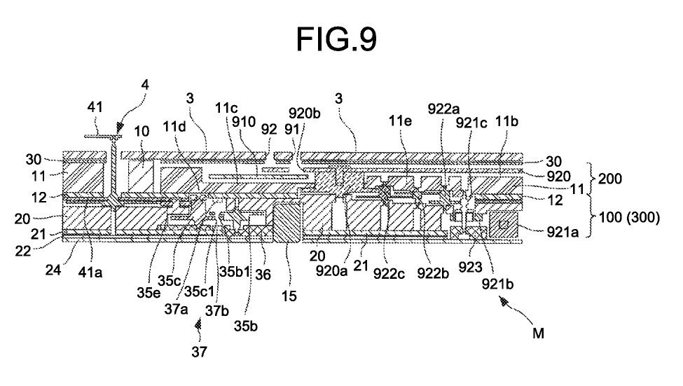

FIG. 9 is a sectional view cut along line C-C in FIG. 8.

The patch antenna 10 is disposed below the dial plate 3 in FIG. 9 on the back of the dial plate 3. Because the patch antenna. 10 receives satellite radio waves at the surface of the dial plate 3 side, the patch antenna 10 can properly receive satellite radio waves when the patch antenna 10 is provided at the dial plate 3 side as much as possible.

The solar cell 30 is disposed at the back of the dial plate 3 at a portion where the patch antenna 10 is disposed and at the portion except for the openings of the one digit date display area 91 and the tens digit date display area 92. The solar cell 30 is provided for charging the secondary battery 15.

The support table 11 is provided below the solar cell 30. Like the solar cell 30, the support table 11 is not provided at the location where the patch antenna 10 is to be disposed. Moreover, a one digit date indicator concave portion 11c and a tens digit date indicator concave portion lib that respectively store therein the one digit date indicator 910 and the tens digit date indicator 920 are provided on the support table 11. The one digit date indicator 910 and the tens digit date indicator 920 are disposed between the one digit date indicator concave portion 11c and the solar cell 30, and between the tens digit date indicator concave portion 11b and the solar cell 30, respectively. An hour wheel train bridge lid for supporting the hour wheel train 35 and a tens digit date wheel train bridge 11e for supporting the tens digit date wheel train 922 are provided on the support table 11.

With such a structure, the patch antenna 10, the one digit date indicator 910, and the tens digit date indicator 920 are disposed in parallel.

A part of the tens digit date indicator 920 is disposed such that the part of the tens digit date indicator 920 is overlapped with the one digit date indicator 910 at the dial plate 3 side than the one digit date indicator 910. The numeral assigned to the tens digit date indicator 920 is visible from the opening of the tens digit date display area 92 of the dial plate 3. The numeral assigned to the one digit date indicator 910 is visible from the opening of the one digit date display area 91 and the opening 920b of the tens digit date indicator 920 of the dial plate 3.

The component layer on which the patch antenna 10, the support table 11, the one digit date indicator 910, the tens digit date indicator 920, and the like are disposed corresponds to the second component layer 200 in the present invention.

The reception substrate 12 is provided below the patch antenna 10 and the support table 11. The reception substrate 12 is electrically connected to the patch antenna 10 and the watch substrate 21. The reception substrate 12 includes openings through which the rotation axes of the 24-hour wheel 41a and the gear 920a of the tens digit date indicator 920, and the tens digit date wheel train 922 pass through.

The main plate 20 is disposed below the reception substrate 12. The reception substrate 12 corresponds to the reception circuit component in the present invention.

The rotation axis of the 24-hour wheel 41a is disposed immediately to the left of the patch antenna 10 in FIG. 9. A gear portion of the 24-hour wheel 41a is disposed below the reception substrate 12. The right portion of the 24-hour wheel 41a is disposed below the patch antenna. 10, and the left portion of the 24-hour wheel 41a is disposed below the support table 11. The 24-hour wheel 41a is received by the main plate 20.

The fifth hour intermediate wheel 35e, the third hour intermediate wheel 35c, and the second hour intermediate wheel 35b of the hour wheel train 35 are disposed at the right side of the patch antenna 10 and below the reception substrate 12 in FIG. 9. The right side portion of the third hour intermediate wheel 35c and the second hour intermediate wheel 35b in the hour wheel train 35 are disposed below the one digit date indicator 910.

The third hour intermediate wheel 35c is received by the hour wheel train bridge 11d. The fifth hour intermediate wheel 35e and the second hour intermediate wheel 35b are received by the main plate 20. Reference numeral 36 is an hour wheel train bridge for supporting the hour wheel train 35.

The hour wheel train 35 includes a hand position detection unit 37. The hand position detection unit 37 includes a light-emitting diode (LED) 37a, a phototransistor 37b, an opening 35b1 formed at a predetermined position of the second hour intermediate wheel 35b, and an opening 35c1 formed at a predetermined position of the third hour intermediate wheel 35c. The hand position is detected when the LED 37a, the opening 35c1, the opening 35b1, and the phototransistor 37b are aligned in a straight line. The position of the hour hand when the hour hand is detected as described above is determined as a predetermined position (for example, 12 o'clock). The watch microcomputer, which is not illustrated, calculates a deviation between the position of the hour hand when the phototransistor 37b receives light from the LED 37a that has passed through the opening 35b1 and the opening 35c1 (for example, 12 o'clock), and the time held by the watch microcomputer. The watch microcomputer then drives and controls the hour motor 34 such that the deviation is eliminated.

The secondary battery 15 is disposed at the right side of the hour wheel train 35 and below the one digit date indicator 910 and the tens digit date indicator 920 in FIG. 9. The secondary battery 15 is charged by the solar cell 30, and the power of the watch 1 is supplied by the secondary battery 15. The lower portion of the secondary battery 15 is not covered by the watch substrate 21, the anti-magnetic plate 22, and the circuit holder 24, so that the secondary battery 15 can be easily replaced.

The third tens digit date intermediate wheel 922c, the second tens digit date intermediate wheel 922b, and the first tens digit date intermediate wheel 922a of the tens digit date wheel train 922 are disposed at the right side of the gear 920a of the tens digit date indicator 920 and below the support table 11 in FIG. 9. The main plate 20 receives the gear 920a of the tens digit date indicator 920 and the tens digit date wheel train 922.

The tens digit date motor 921 including a coil block 921a, a stator 921b, and a rotor 921c is disposed at the right side of the first tens digit date intermediate wheel 922a and below the support table 11 in FIG. 9.

The watch substrate 21 is disposed below the main plate 20.

The component layer on which the reception substrate 12, the main plate 20, the 24-hour wheel 41a, the hour wheel train 35, the hour wheel train bridge 36, the secondary battery 15, most part of the tens digit date wheel train 922, the tens digit date motor 921, the watch substrate 21, and the like are disposed corresponds to the first component layer 100 in the present invention. A. motor driving circuit, which is not illustrated, and the like are also disposed on the first component layer 100.

Because the reception substrate 12 is included in the first component layer 100, a reception block 300 is included in the first component layer 100.

The anti-magnetic plate 22 is disposed below the watch substrate 21. The circuit holder 24 is disposed below the anti-magnetic plate 22. In the present embodiment, the circuit holder 24 holds the watch substrate 21 and the anti-magnetic plate 22.

As illustrated in FIG. 8 and FIG. 9, the patch antenna 10 is disposed such that the patch antenna 10 is overlapped with the front side of a part of the 24-hour wheel 41a, the day motor 83, and the day indicator 81a. Thus, it is possible to secure space for disposing the one digit date indicator 910 and the tens digit date indicator 920 on the second component layer 200. Consequently, it is possible to dispose the patch antenna 10, the one digit date indicator 910, and the tens digit date indicator 920 in parallel.

Moreover, the components such as the 24-hour wheel 41a, the day motor 83, the day indicator 81a, and the watch substrate 21 are metal components, and these components are disposed below the patch antenna 10. Consequently, it is possible to prevent the reception sensitivity from. deteriorating due to noise.

In the present embodiments, time information is displayed by the upper side display components and the lower side display components in the first embodiment and the second embodiment, and time information is displayed by the upper side display components in the third embodiment. However, it is not limited thereto, and the time information may also be displayed only by the lower side display components.

The reception substrate 12 is disposed at a side opposite from that of the second component layer 200 with the first component layer 100 interposed therebetween in the first embodiment and the second embodiment. The reception substrate 12 is disposed on the first component layer 100 in the third embodiment. Alternatively, the reception substrate 12 may be disposed on the second component layer 200 when there is enough space in the second component layer 200.

If space permits, the reception circuit component may also be mounted on another substrate such as the watch substrate 21 instead of the reception substrate 12.

In other words, depending on the space of each layer, the reception circuit component may be suitably disposed on any one of the layers.

Moreover, in the embodiments, the small hand is included as the upper side display component. However, the small hand is not indispensable, and a watch may only include the hour hand, the minute hand, and the second hand, and may not include a small hand as the upper side display component, for example. Consequently, the components relating to the small hand will be simplified, and the watch may have a two-layer structure including the first component layer and the second component layer as in the above-described embodiments, or may have a three-layer structure including a reception block.

Modifications

Technical matters in any one of the embodiments may be applied to any of the other embodiments and used as an example.

The watch includes the dial plate, the antenna that receives satellite radio waves, the upper side display component fitted to the rotation axis projecting toward the visible side than the dial plate, and the lower side display component that is disposed at the rear surface side of the dial plate in the exterior of the dial plate and that is capable of displaying information different from that of the upper side display component. The watch displays time information by at least one of the upper side display component and the lower side display component. The movement in the watch includes the first component layer on which at least a part of the wheel train mechanism for driving the upper side display component, a motor for driving the wheel train mechanism, and a motor driving circuit for driving the motor are disposed, and the second component layer that is positioned between the first component layer and the dial plate, and on which the lower side display component and at least a part of the driving component for driving the lower side display component are disposed. The antenna is disposed on the second component layer so as to be planarly overlapped with a metal component disposed on the first component layer. The reception circuit component for receiving predetermined radio waves by the antenna is disposed on the first component layer, the second component layer, or the layer opposite from the second component layer with the first component layer interposed therebetween. Consequently, it is possible to secure space in parallel with the antenna, and dispose the components relating to additional functions such as the liquid crystal display device and the date indicator, and the components relating to the multiple hands. Thus, a degree of freedom in designing the arrangements of the components is increased. Moreover, it is possible to prevent the reception sensitivity of the antenna from deteriorating.

Tn addition to the above, the lower side display component is the liquid crystal panel or the date indicator for displaying a date. Consequently, it is possible to dispose the liquid crystal panel or the date indicator for displaying a date on the space secured in parallel with the antenna.

In addition to the above, the upper side display component includes a small hand, and the gear fitted to the rotation axis fixed with the small hand is a metal component. Consequently, it is possible to prevent the reception sensitivity of the antenna from deteriorating.

In addition to the above, the operation mechanism that performs an operation relating to the display operation of the upper side display component or the lower side display component using the external operation member is disposed on the first component layer. Because the operation mechanism is a metal component, it is possible to secure space in parallel with the patch antenna at the portion other than the operation mechanism. It is also possible to prevent the reception sensitivity of the antenna from deteriorating.

Although the invention has been described with respect to specific embodiments for a complete and clear disclosure, the appended claims are not to be thus limited but are to be construed as embodying all modifications and alternative constructions that may occur to one skilled in the art that. fairly fall within the basic teaching herein set forth.

What is claimed is:

1. A watch comprising:
a dial plate;
an antenna that receives a satellite radio wave;
an upper side display component fitted to a rotation axis projecting toward a visible side than the dial plate; and
a lower side display component that is disposed at a rear surface side of the dial plate in an exterior of the dial plate and that is capable of displaying information different from that of the upper side display component, wherein
the watch displays time information by at least one of the upper side display component and the lower side display component,
a movement in the watch includes
a first component layer on which at least a part of a wheel train mechanism for driving the upper side display component, a motor for driving the wheel train mechanism, and a motor driving circuit for driving the motor are disposed, and
a second component layer that is positioned between the first component layer and the dial plate, and on which the lower side display component and at least a part of a driving component for driving the lower side display component are disposed,
the antenna is disposed on the second component layer so as to be planarly overlapped with a metal component disposed on the first component layer, and
a reception circuit component for receiving a predetermined radio wave by the antenna is disposed on the first component layer, the second component layer, or a layer opposite from the second component layer with the first component layer interposed therebetween.

2. The watch according to claim 1, wherein.
the lower side display component is a liquid crystal panel or a date indicator for displaying a date.

3. The watch according to claim 1, wherein
the upper side display component includes a small hand, and
a gear fitted to the rotation axis fixed with the small hand is the metal component.

4. The watch according to claim 2, wherein the upper side display component includes a small hand, and
a gear fitted to the rotation axis fixed with the small hand is the metal component.

5. The watch according to claim 1, wherein
an operation mechanism that performs an operation relating to a display operation of the upper side display component or the lower side display component using an external operation member is disposed on the first component layer, and
the operation mechanism is the metal component.
